(19) United States
(12) Patent Application Publication
(10) Pub. No.: US 2008/0020748 A1
(43) Pub. Date: Jan. 24, 2008

(54) Method and apparatus for quick recovery of dropped cellular phone calls

(76) Inventors: Eric G. Parker, Plantation, FL (US); Michael A. Criger, Lake Worth, FL (US); Gregory S. Smith, Ocean Ridge, FL (US)

Correspondence Address: INGRASSIA FISHER & LORENZ, P.C., 7150 E. CAMELBACK, STE. 325, SCOTTSDALE, AZ, 85251, US

(21) Appl. No.: 11/490,923

(22) Filed: Jul. 21, 2006

(51) Int. Cl. H04Q 7/20

(52) U.S. Cl. 455/423

(57) ABSTRACT

A wireless communication (120) device for placing calls within a wireless communication system (100) on a plurality of channels is provided. The wireless communication unit (120) includes a transceiver (204) for transmitting and receiving radio frequency (RF) signals on the plurality of channels, a signal detector (220), a network scanner (222) and a controller (206). The signal detector (220) detects whether a call on one of the plurality of channels has been dropped (304). The network scanner (222) controls which of the plurality of channels the transceiver receives signals on and which of the plurality of channels the transceiver transmits signals on. The controller (206) automatically increases a scan rate (308) of the network scanner (222) in response to the signal detector (220) determining that the call has been dropped (304).

### FIELD OF THE INVENTION

The present invention generally relates to wireless communication devices, and more particularly relates to a method and apparatus for quick recovery of dropped cellular phone calls.

### BACKGROUND OF THE INVENTION

When a call is dropped (i.e., a signal is lost), conventional wireless communication devices, such as third generation (3G) cellular telephone mobile handsets, will initially attempt to re-establish communications with the base station or cell handling the call in accordance with network parameters. For example, the current scan algorithms for 3G cellular telephone networks use a designated timer to try and re-establish a call with the last cell. The value of this timer is established by the network, where the maximum value is twenty seconds and a typical value is five seconds. After re-establishing the call with the last cell within the timer's time range fails (such as during a roaming situation), the cellular telephone mobile handset algorithms decide how quickly to scan for a new base station. The type of scan (e.g., power save or normal) and the scan rate (e.g., Slow, Medium, Fast or Continuous) determine how quickly the user may be able to register to a new network. The user typically selects the scan rate in response to prompts on a user interface, basing his choice on a tradeoff of power consumption vs. response time. During hands-free operation, such as while operating a car, selection of the scan rate is both problematic and slow.

Thus, what is needed is a method and apparatus for quick recovery of dropped network calls. Furthermore, other desirable features and characteristics of the present invention will become apparent from the subsequent detailed description of the invention and the appended claims, taken in conjunction with the accompanying drawings and this background of the invention.

### BRIEF DESCRIPTION OF THE DRAWINGS

The present invention will hereinafter be described in conjunction with the following drawing figures, wherein like numerals denote like elements, and

FIG. 1 is a block diagram of a wireless communication system in accordance with an embodiment of the present invention;

FIG. 2 is a block diagram of a wireless communication device of the communication system of FIG. 1 in accordance with the embodiment of the present invention; and

FIG. 3 is a flow chart of the quick recovery system of the wireless communication device of FIG. 2 in accordance with the embodiment of the present invention.

### DETAILED DESCRIPTION OF THE INVENTION

A method for recovery of dropped calls in a wireless communication system communicating on a plurality of channels includes automatically increasing a scan rate of a network scanner from a first scan rate to a second scan rate in response to detecting that a call has been dropped, the second scan rate being faster than the first scan rate.

In addition, a wireless communication device for placing calls within a wireless communication system on a plurality of channels includes a transceiver for transmitting and receiving radio frequency (RF) signals on the plurality of channels, a signal detector, a network scanner and a controller. The signal detector detects whether a call on one of the plurality of channels has been dropped. The network scanner controls which of the plurality of channels the transceiver receives signals on and which of the plurality of channels the transceiver transmits signals on. The controller automatically increases a scan rate of the network scanner from a first scan rate to a second scan rate in response to the signal detector determining that the call has been dropped, the second scan rate being faster than the first scan rate.

The following detailed description of the invention is merely exemplary in nature and is not intended to limit the invention or the application and uses of the invention. Furthermore, there is no intention to be bound by any theory presented in the preceding background of the invention or the following detailed description of the invention.

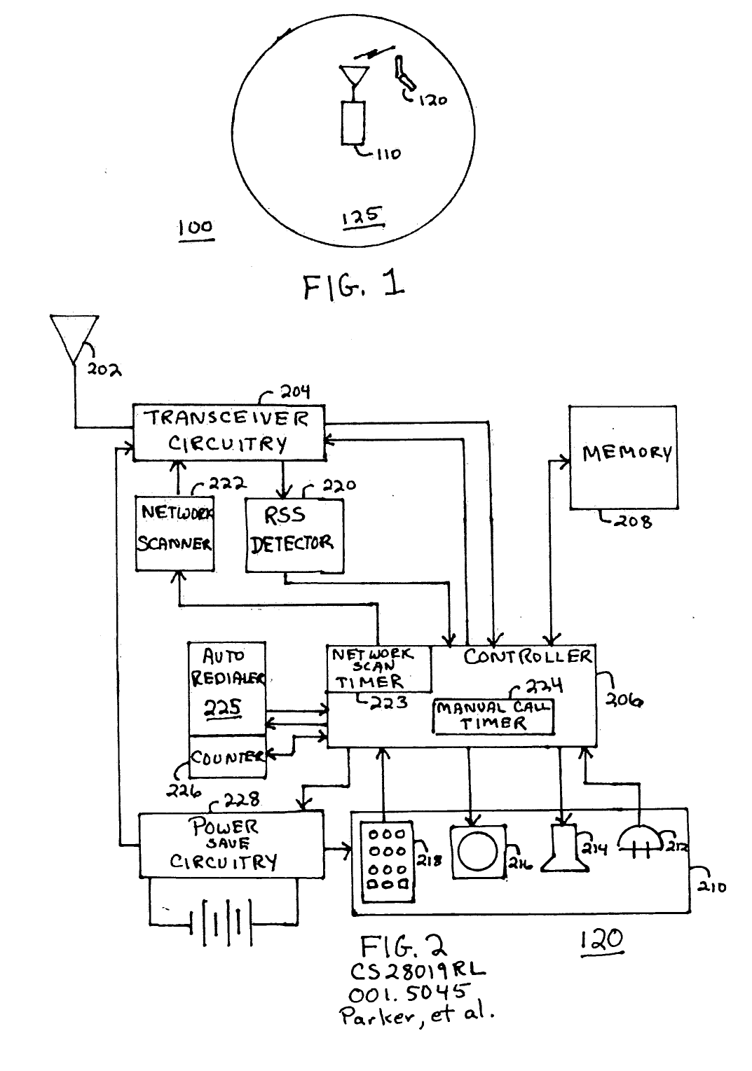

Referring to FIG. 1, a wireless communication system 100 in accordance with an embodiment of the present invention includes a base station 110 and a wireless communication device 120. The plurality of base station 100 communicates with the wireless communication device 120 via radio frequency (RF) signals on a plurality of RF channels. Associated with the base station 110 is a coverage area or cell 125 wherein the wireless communication device 120 can receive signals from and transmit signals to the base station 110.

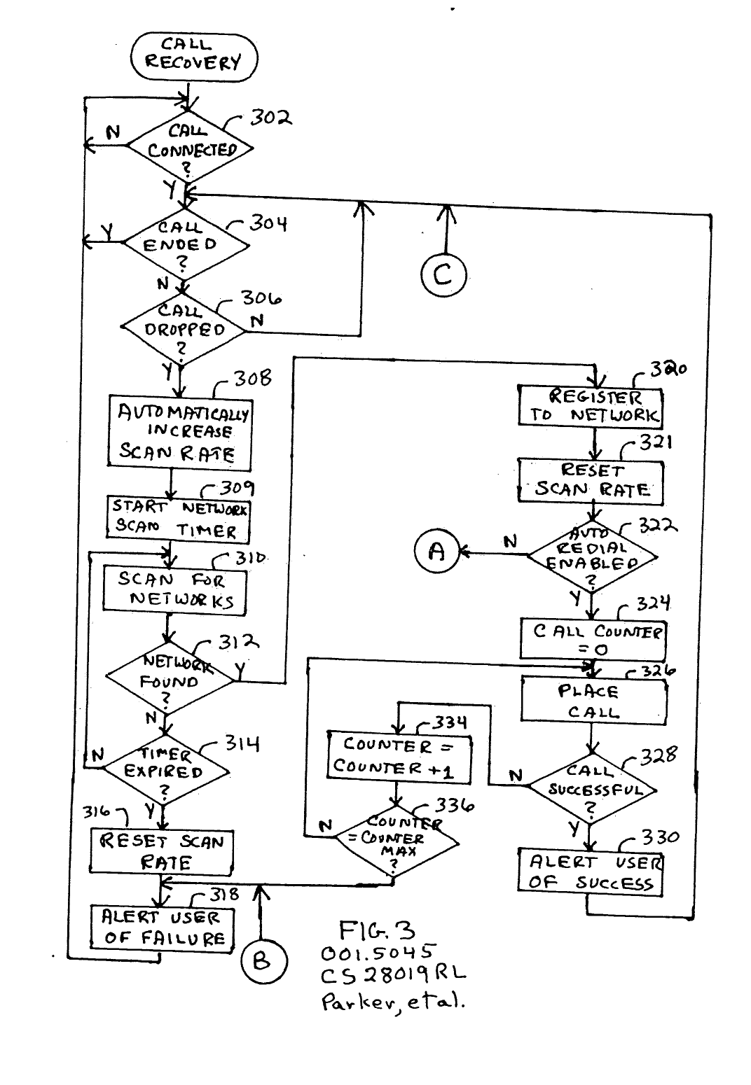

Referring to FIG. 2, a wireless communication device 120 in accordance with the embodiment of the present invention is shown. The wireless communication device 120 includes an antenna 202 for receiving and transmitting RF signals. The antenna 202 is coupled to a transceiver 204 for transmitting and receiving RF signals on the plurality of channels in a manner familiar to those skilled in the art. Receiver circuitry within the transceiver 204 demodulates and decodes the RF signals received from the base station 110 (FIG. 1) to derive information therefrom and is coupled to a controller 206 for providing the decoded information thereto for utilization thereby in accordance with the function(s) of the wireless communication device 120. The controller 206 also provides information to transmitter circuitry within the transceiver 204 for encoding and modulating information into RF signals for transmission from the antenna 202.

As is well-known in the art, the controller 206 is typically coupled to a memory device 208 and user interface devices 210 to perform the functions of the wireless communication device 120. The user interface devices 210 includes a microphone 212, a speaker 214 and a display 216 which may be designed to accept touch screen inputs. The user interface devices 210 also include one or more key inputs 218, such as a keypad.

In accordance with the embodiment of the present invention, the wireless communication device 120 also includes a signal detector 220, such as a received signal strength (RSS) detector, which is coupled to a receiver portion of the transceiver 204 to detect a loss of signal on one of the plurality of channels in response to detecting a signal strength on the one of the plurality of channels less than a predetermined signal strength. The RSS detector 220 signals the controller 206 that a call has been dropped in response to detecting a loss of signal.

When the controller 206 is signaled by the RSS detector 220 that a call has been dropped, in accordance with the embodiment of the present invention, automatically signals a network scanner 222 to increase a scan rate thereof. The network scanner 222 is coupled to the transceiver 204 and, when active, controls which of the plurality of channels the transceiver 204 transmits and receives RF signals on by automatically scanning through a set of network frequencies in a predetermined manner as is well known to those skilled in the art. The controller 206 activates the network scanner for a predetermined time and, in accordance with the embodiment of the present invention, includes a network scan timer 223 which is activated when the controller 206 activates the network scanner 222 to scan for networks. The network scan timer 223 measures the predetermined time interval for network scanning and, when the timer 223 expires at the end of the predetermined time interval, the controller 206 inactivates the network scanner 222 and, preferably, signals the user interface circuitry 210 to alert a user of the wireless communication device 120 that an attempt to connect to a network has failed. A second timer, a manual call timer 224, is also enabled in the controller 206 to measure a predetermined time interval for allowing a user to manually place a call before alerting a user of the wireless communication device 120 that an attempt to connect to a network has failed.

The wireless communication device 120 also includes an auto redialer 225. The auto redialer 225 could be implemented in the controller 206 or, as depicted, coupled to the controller 206. In operation, the auto redialer 225, when activated by signals from the controller 206, places a call by providing signals to the controller 206 to automatically redial a predetermined telephone number, such as a telephone number previously dialed. In accordance with the embodiment of the present invention, an auto redial counter 226 is coupled to the auto redialer 225 and the controller 206 to count for the controller 206 the number of times the auto redialer 225 attempts to redial a call and, after a predetermined number of attempts to place the call have been made, the counter 226 signals the controller 206 that the predetermined number of attempts to place the call have been unsuccessful.

The controller 106 is also coupled to power save circuitry 228 for controlling the operation thereof to conserve power by turning on and off components of the wireless communication unit 120 such as the transceiver 204 and the user interface devices 210. The predetermined time interval that the auto redialer 225 attempts to reconnect the call is defined by weighing the power conservation concerns against the call completion reliability concerns of the wireless communication unit 120 and, in accordance with the embodiment of the present invention, is preferably no more than thirty seconds.

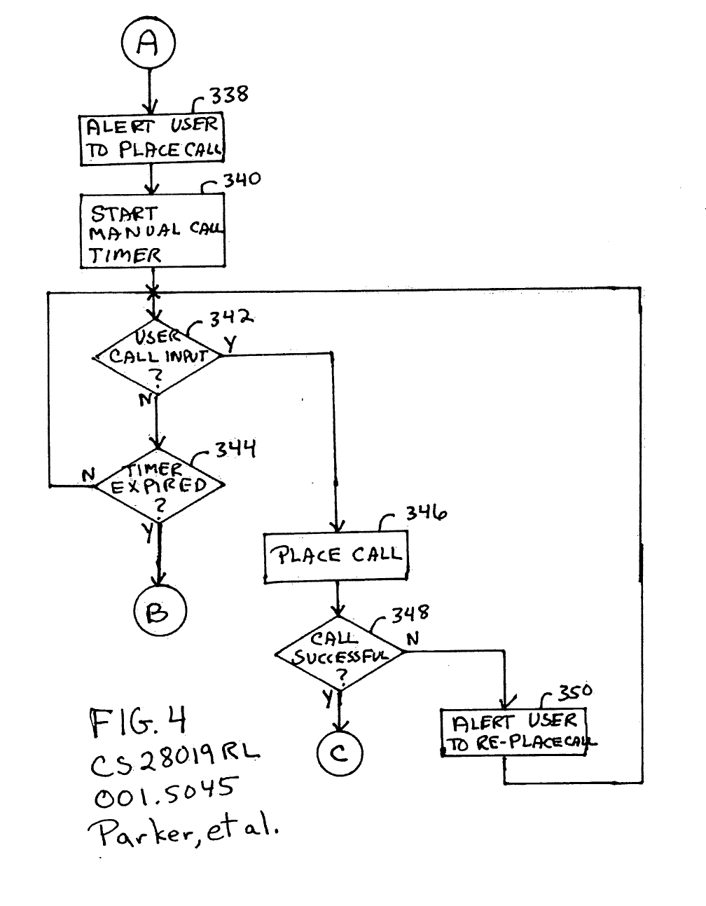

FIGS. 3 and 4 comprise a flowchart depicting an exemplary call recovery operation of the controller 206 in accordance with the embodiment of the present invention. Referring to FIG. 3, operation of the controller 206 in accordance with the embodiment of the present invention begins by determining whether a call is connected 302 and whether the connected call is ended 304. If a call is connected 302 and not yet ended 304, processing next determines in response to signals from the RSS detector 220 whether a call has been dropped due to loss of signal 306. As described above, the RSS detector 220 signals the controller 206 that a call has been dropped in response to detecting a signal strength on the communication channel less than a predetermined signal strength. If it is determined that a call has not been dropped 306, processing returns to await either the end of the call 304 or the call being dropped 306. When the call is ended 304, processing returns to await the connection of a subsequent call 302.

In accordance with the embodiment of the present invention, when an active call 302, 304 is dropped 306, the controller 206 signals the network scanner 222 to automatically increase the scan rate 308 to, for example, a continuous scan rate. While increasing the scan rate to a continuous scan rate 308 is preferable, automatically increasing the scan rate to any increased scan rate that is a higher scan rate than a typical, power-saving scan rate of the network scanner 222 may be implemented within the spirit of the present invention.

Thus, operation in accordance with the present invention automatically trades off power conservation, a primary concern in the portable wireless communication unit 120, for an increased scan rate to speed call recovery. Some prior art solutions utilize auto redialers to replace a call to a number when the call becomes disconnected. While this conventional response to call drop can quickly reconnect a call when the network connection is not broken (such as a slight interruption in the signal which causes the call drop), this response has the drawback that it cannot quickly scan and locate a network to register to and then attempt to reconnect the call. In addition, while this solution and other prior art solutions do not increase the scan rate in a dropped call situation, some prior art implementations offer user selectability for increasing the scan rate when a call is dropped. Not only do such prior art solutions result in slower call recovery, user selection in accordance with some prior art implementations is not only slow, but also problematic in, for example, situations such as hands-free operation. This is an increased concern today where many states are legislating hands-free operation as the only legal operation for automobile drivers. Therefore, the present invention advantageously provides automatically increasing the scan rate 308 of the network scanner 222 without user intervention to overcome the shortcomings and drawbacks of prior art solutions for call recovery.

After automatically increasing the scan rate 308, the network scanner 222 scans for networks 310 by selecting a next channel in a predetermined channel order for scanning and determining whether a network is operational on that channel 312. The controller 206 permits the network scanner 222 to continue to scan for networks 310 at the increased scan rate until either a network is found 312 or the controller 206 determines that a predetermined time interval for network scanning, as measured by a network scanning timer 223 in the controller 206, has expired 314.

When the network scanning timer 223 indicates that the predetermined time interval has expired 314, the controller 206 signals the network scanner 222 to reset the scan rate to the previous scan rate value 316 (i.e., the value set before step 308) and the controller 206 signals the user interface circuitry 210 to present a predetermined alert to a user of the wireless communication device 120 indicating a failed attempt to reconnect a dropped call 318. The predetermined alert 318 could be a predetermined message presented on the display 216 or, in consideration of the particular applicability of the present invention to hands-free operation, could be an audio alert presented via the speaker 214. After presentation of the predetermined alert 318, processing in accordance with the embodiment of the present invention returns to await occurrence of an active call 302, 304 being dropped 306.

If, on the other hand, a network is found 312, the controller provides the appropriate information to the transceiver 204 for transmitting to the network to register the wireless communication unit 120 with the network 320 in accordance with network specific techniques well known to those skilled in the art. After registering with the network 320, the controller 206 provides signals the network scanner 222 to reset the scan rate 321 to the previous scan rate (i.e., the scan rate before step 308, which is typically a power conserving, slower scan rate). Next, the controller 206 determines whether the auto redialer 225 is enabled 322. If the auto redialer 225 is enabled 322, the controller 206 initializes the auto redial counter 226 by setting a counter to zero 324 and provides signals to the auto redialer 225 to activate the auto redialer 225 to redial the call 326. If the call is successful 328, the controller 206 provides signals to the user interface circuitry 210 to present a predetermined alert to the user that the call has been successfully redialed 330. Processing in accordance with the embodiment of the present invention then returns to await occurrence of the call ending 304 or the call being dropped 306.

If the call is not successful 328, the auto redial counter 226 increments the counter 334 and the controller 206 determines whether the counter has reached a maximum counter value 334. If the counter has not reached the maximum counter value 336, processing returns to attempt to re-place the call 326. When the counter reaches the maximum counter value 336, the controller 206 signals the user interface circuitry 210 to present a predetermined alert to a user of the wireless communication device 120 indicating a failed attempt to reconnect a dropped call 316. Then processing in accordance with the embodiment of the present invention returns to await occurrence of an active call 302, 304 being dropped 306.

If the auto redialer is not enabled 322, the embodiment of the present invention could preferably also allow for manually placing the call by, referring to FIG. 4, the controller 206 providing signals to the user interface circuitry 210 to alert the user of the wireless communication device 120 to provide an input to replace the call 338. The controller 206 starts 340 the manual call timer 224 and processing awaits either reception of a user input 342 or expiration of the predetermined time interval for manually placing a call 344 as measured by the manual call timer 224. The user input could be providing a predetermined input to redial the last number dialed, or the input could be manually entering a telephone number. When a user input is received 342, a call is placed in accordance with the user input 346. If the call is successful 348, the user does not need to be further alerted as normal call setup (dial tone, ring tone or person answering the call) will indicate to the user that the call is successful. Processing then returns to await the call ending 304 or the call being dropped 306.

If the call is not successful 348, the controller 206 alerts the user to re-place the call 350. The controller 206 could provide normal call setup failure signals to the user, such as a busy signal. Alternatively, the controller 206 could provide signals to the user interface circuitry to provide the same alert as step 338. Processing then returns to await either a user call input 342 or expiration 344 of the manual call timer 224. When the manual call timer 224 expires 344 without a user call input 342, the controller 206 signals the user interface circuitry 210 to present the predetermined user alert indicating a failed attempt to reconnect a dropped call 316 and processing in accordance with the embodiment of the present invention returns to await occurrence of an active call 302, 304 being dropped 306.

It can thus be seen that operation in accordance with the present invention provides an advantageous method and apparatus in a wireless communication unit 120 for quick recovery of wireless network calls. While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

What is claimed is:

1. A method for recovery of dropped calls in a wireless communication system communicating on a plurality of channels, the method comprising the steps of:
detecting a call has been dropped; and
automatically increasing a scan rate of a network scanner from a first scan rate to a second scan rate in response to detecting that the call has been dropped, wherein the second scan rate is faster than the first scan rate.

2. The method of claim 1 wherein the step of detecting a call has been dropped comprises the step of detecting a loss of signal on one of the plurality of channels.

3. The method of claim 2 wherein the step of detecting a loss of signal comprises the step of detecting a signal strength less than a predetermined signal strength on the one of the plurality of channels.

4. The method of claim 1 further comprising the steps of:
switching from one of the plurality of channels to another one of the plurality of channels at the second scan rate;
determining whether a network is present on the another one of the plurality of channels; and
if no network is present, repeating the switching and determining steps at the second scan rate for a next one of the plurality of channels.

5. The method of claim 4 further comprising the step of placing a call on one of the plurality of channels in response to determining that a network is present on the one of the plurality of channels.

6. The method of claim 5 wherein the call is a wireless telephone call to a telephone number, and wherein the step of placing the call comprises the step of auto redialing the telephone number in response to determining that a network is present on the one of the plurality of channels.

7. The method of claim 5 further comprising the step of decreasing the scan rate of the network scanner from the second scan rate to the first scan rate in response to successfully placing the call on the one of the plurality of channels.

8. The method of claim 4 wherein the step of repeating the switching and determining steps comprises the step of repeating the switching and determining steps at the second scan rate for a next one of the plurality of channels for a predetermined time interval.

9. The method of claim 8 further comprising the step of decreasing the scan rate of the network scanner from the second scan rate to the first scan rate in response to repeating the switching and determining steps for the predetermined time interval.

10. The method of claim 9 further comprising the step of alerting a user of a failed attempt to reconnect the dropped call in response to repeating the switching and determining steps for the predetermined time interval.

11. A wireless communication device for placing calls within a wireless communication system on a plurality of channels, the wireless communication device comprising:
a transceiver for transmitting and receiving radio frequency (RF) signals on the plurality of channels;
a signal detector coupled to the transceiver and detecting whether a call on one of the plurality of channels has been dropped;
a network scanner coupled to the transceiver and controlling which of the plurality of channels the transceiver receives signals on and which of the plurality of channels the transceiver transmits signals on; and
a controller coupled to the transceiver, the signal detector and the network scanner and automatically increasing a scan rate of the network scanner from a first scan rate to a second scan rate in response to the signal detector determining that the call has been dropped, wherein the second scan rate is faster than the first scan rate.

12. The wireless communication device of claim 1I wherein the second scan rate is a continuous scan rate.

13. The wireless communication device of claim 11 wherein the signal detector determines that a call has been dropped in response to detecting a loss of signal on the one of the plurality of channels.

14. The wireless communication device of claim 13 wherein the signal detector is a received signal strength detector which detects a loss of signal on the one of the plurality of channels in response to detecting a signal strength less than a predetermined signal strength on the one of the plurality of channels.

15. The wireless communication device of claim 11 wherein the controller signals the network scanner to switch the transceiver from receiving RF signals on one of the plurality of channels to receiving RF signals on another one of the plurality of channels at the second scan rate, determines whether a network is present on the another one of the plurality of channels in response to the signal from the signal detector, and, if no network is present, repeatedly switching and determining at the second scan rate for subsequent ones of the plurality of channels.

16. The wireless communication device of claim 15 further comprising an auto redialer coupled to the controller and places a call by providing signals to the controller to automatically redial a predetermined telephone number, wherein the controller signals the auto redialer to place a call to the predetermined telephone number on the another one of the plurality of channels in response to determining that a network is present on the another one of the plurality of channels.

17. The wireless communication device of claim 16 wherein the controller decreases the scan rate of the network scanner from the second scan rate to the first scan rate in response to the auto redialer successfully placing the call on the another one of the plurality of channels.

18. The wireless communication device of claim 15 further comprising a timer coupled to the controller for measuring a predetermined time interval for the controller to repeatedly switch and determine at the second scan rate.

19. The wireless communication device of claim 18 wherein the controller decreases the scan rate of the network scanner from the second scan rate to the first scan rate in response to a signal from the timer indicating that the predetermined time interval has expired.

20. The wireless communication device of claim 19 further comprising a user interface device coupled to the controller and alerting a user of the wireless communication device, wherein the controller signals the user interface device to alert the user of a failed attempt to reconnect a dropped call in response to the signal from the timer indicating that the predetermined time interval has expired.
